(19) United States
(12) Patent Application Publication
(10) Pub. No.: US 2011/0035038 A1
(43) Pub. Date: Feb. 10, 2011

(54) System and Method for Making a Three-Dimensional Reproduction of a Relief Surface

(76) Inventor: Jacobus Maria Franciscus Keulen, Waalre (NL)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/864,599

(22) PCT Filed: Jan. 27, 2009
(86) PCT No.: PCT/NL09/00017

§ 371 Date: Oct. 29, 2010

(30) Foreign Application Priority Data
Jan. 29, 2008 (NL) 1034969

(51) Int. Cl. G06F 17/50

(52) U.S. Cl. 700/98

(57) ABSTRACT

The invention relates to a method for making a three-dimensional reproduction of a relief surface, which method comprises the following steps: scanning the surface at least twice by means of a scanner to be connected to a computer, the first scan being carried out under different conditions than the second scan, comparing the scans with each other by means of the computer in order to obtain a digital three-dimensional image of the surface relief, forming a mould by means of a processing machine on the basis of said digital three-dimensional image of the surface relief, making the three-dimensional reproduction of the surface by means of said mould.

The invention relates to a method as well as a system for making a three-dimensional reproduction of a relief surface.

The object of the method according to the present invention is to make an exact reproduction of a relief surface in a cost-efficient manner.

This object is accomplished with the method according to the present invention in that the method comprises the following steps:

scanning the surface at least twice by means of a scanner to be connected to a computer, the first scan being carried out under different conditions than the second scan,

comparing the scans with each other by means of the computer in order to obtain a digital three-dimensional image of the surface relief,

forming a mould by means of a processing machine on the basis of said digital three-dimensional image of the surface relief,

making the three-dimensional reproduction of the surface by means of said mould.

Using said method, it is possible to make practically exact replicas of paintings, works of art and other relief surfaces. First, the surface to be reproduced is scanned by means of a scanner. Said scanner is to be connected to a computer via cables or by wireless means, using known techniques such as Bluetooth, or via a LAN (Local Area Network). The scanner may be provided with a memory, in which the scanning data can be stored, so that the scanner need not be connected to the computer during the scanning process and the transfer of the scanning data can take place at a later point in time. The (photographic) scanner uses normal, visible light, because practically any object can be scanned by means of visible light without causing damage to the object. When two, or possibly more, scans are carried out under different scanning conditions, this will result in differences in the scanning data. Via said differences in the scanning data of two or more scans, the three-dimensional information (x-y-z coordinates) of the surface are calculated by computer and digitally recorded in the form of a digital three-dimensional image of the surface relief. Subsequently, said digital three-dimensional image of the surface relief is converted in the computer into machine instructions for a processing machine, such as a milling machine or relief-forming machines, such as a “3D print machine”, for forming a mould. The invention is not limited to the processing machines mentioned herein, other techniques for forming the mould are also possible. The mould that is formed is suitable for reproducing the relief inter alia by thermoforming, vacuum forming, embossing, pressing or casting.

One embodiment of the method according to the present invention is characterised by digitizing at least one scan by computer so as to obtain colour data of the scanned surface.

The scan(s) made is (are) also used for digitally recording the colour image or, in other words, the colour data of the surface. The advantage of the present method is that because the same scans are used for the colour image and the relief image, said images fit exactly together. When the method according to the present invention is used, the colour image need not be “digitally” processed to fit the relief image, therefore.

Another embodiment of the method according to the present invention is characterised by making a flat colour copy on the basis of the colour data, of which flat colour copy a three-dimensional, coloured reproduction of the surface can be made by means of the mould.

The flat colour copy can be made by using known means, such as a printer, for example. The main advantage, however, is that because the same scans are used, the relief image of the mould corresponds exactly to the colour image of the colour copy, thus making it possible to make a three-dimensional, coloured reproduction of the surface in a relatively simple and exact manner.

Yet another embodiment of the method according to the present invention is characterised by digitizing at least one of the two scans by computer so as to obtain colour data of the scanned surface for use in colouring the three-dimensional reproduction of the surface made by means of the mould.

In this way a three-dimensional reproduction of the surface is first made, after which the colour image or the colour data obtained on the basis of at least one scan, is/are used for colouring the reproduction. If desired, the colours may differ from the original, for example in that different colours are consistently used.

Another embodiment of the method according to the present invention is characterised by embossing paper, cardboard or plastic by means of the mould.

It is advantageous to use the graphic embossing technique as a method of reproducing works of art, because this makes it possible to form three-dimensional, preferably coloured reproductions of a surface, for example a well-known painting, on paper and/or cardboard. This technique is more suitable for use with the materials that are generally used in the world of art and in the graphic industry than thermoforming, for example. Furthermore, the making of an exact reproduction of the colour image with a relief can be realised with greater accuracy, in a simpler manner and at lower cost.

Yet another embodiment of the method according to the present invention is characterised in that the scanning conditions are varied for a first scan and a second scan, which is done either by varying an angle at which scanning takes place or by varying the exposure to light of the surface to be scanned, with the surface relief being digitised by computer by comparing the differences between the first scan and the second scan at every point on the scanned surface.

In this way an exact digital three-dimensional image of the surface relief can be obtained in a relatively simple manner.

Yet another embodiment of the method according to the invention is characterised in that the exposure to light is varied for at least the first and the second scan, which is done either by varying the light intensity of at least two light sources for lighting the surface to be scanned or by varying the lighting angle of at least one light source for lighting the surface to be scanned.

This is a relatively simple embodiment, by means of which differences in light intensity can be realised at every point on the surface during the scans in a simple manner, as a result of which an exact digital three-dimensional image of the surface relief is obtained by means of the computer.

Yet another embodiment of the method according to the invention is characterised in that the surface to be scanned is continuously and uniformly exposed to light, and a position of a scanner is moved after a first scan has been made so as to carry out the second scan, thus varying the angle at which scanning takes place.

An alternative to exposing the surface to light in a different manner by means of at least one light source is to move or rotate the position of the scanner relative to the surface to be scanned, so that the first scanning operation is carried out at a first scanning angle, preferably perpendicular to the surface to be scanned, whilst the second scanning operation is carried out at a second scanning angle, which preferably includes an angle of 10-40 degrees to the normal. The at least two scans of every point on the surface can be carried out with the same exposure to light of the surface, since the relief is determined by means of a trigonometric measurement if two scans are carried out at different scanning angles. This embodiment is very easy to carry out and leads to an exact digital three-dimensional image of the surface of the original.

The invention will now be explained with reference to the appended figures, in which:

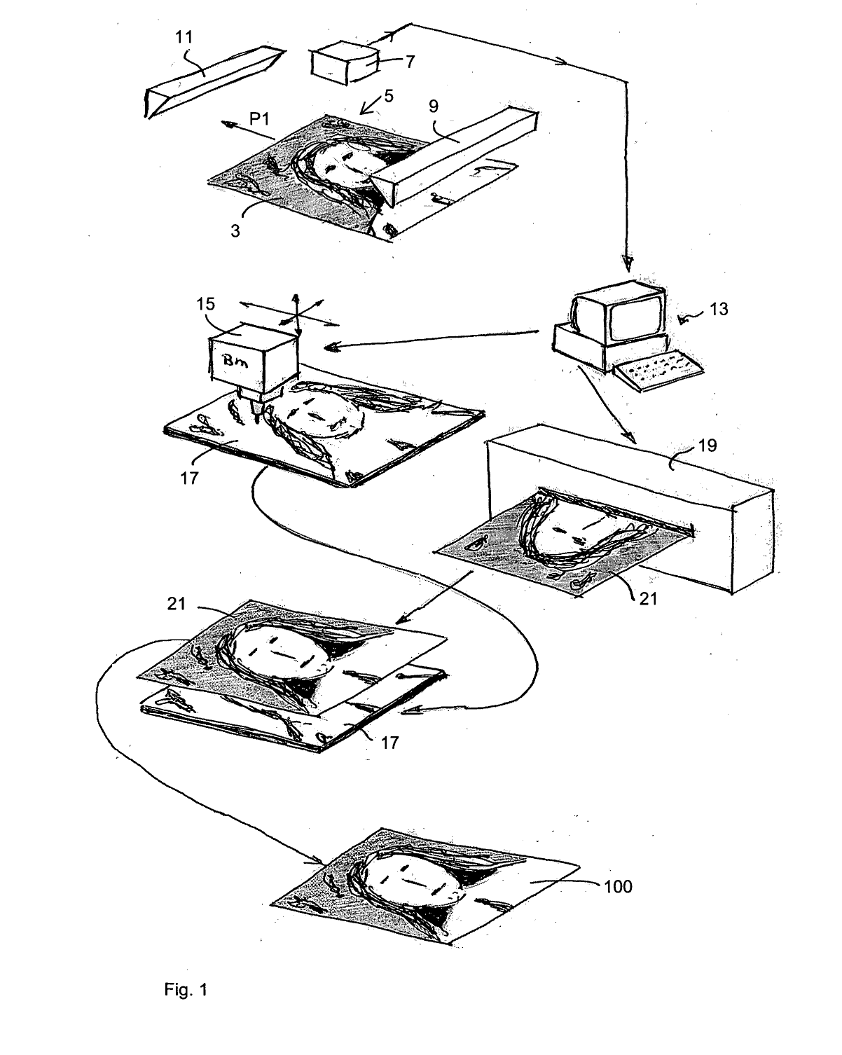

FIG. 1 is a schematic representation of the steps to be carried out of the method according to the present invention;

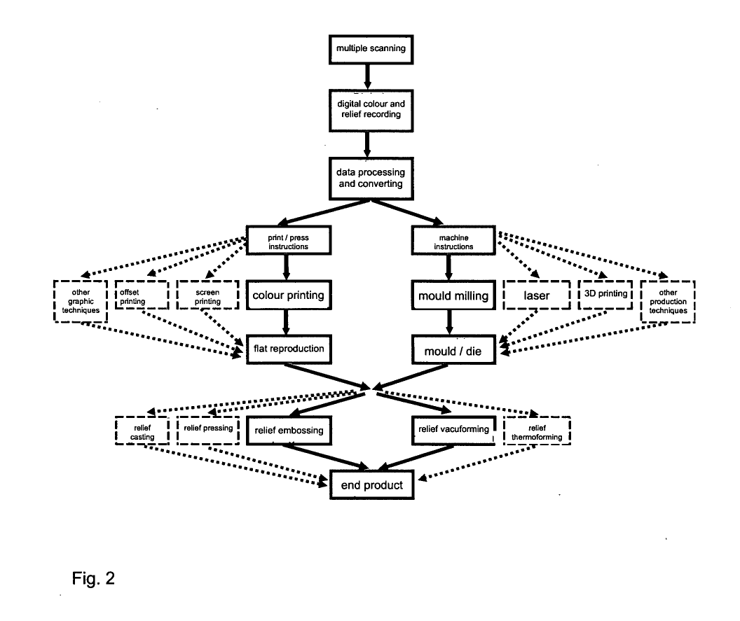

FIG. 2 shows a flow diagram of the steps to be carried out of the method according to the present invention.

FIG. 1 is a schematic representation of the steps that are to be carried out in order to obtain a three-dimensional reproduction 100 of a relief surface 3 of an original 5. In the first step, the uppermost illustration in FIG. 1, the relief surface 3 of the original 5 is scanned by means of a scanner 7. During the first scan to be carried out by means of the scanner 7, the surface 3 is exposed to light from at least one of the light sources 9, 11. While scanning by means of the scanner 7 takes place, the original 5 moves in the direction indicated by the arrow P1, so that the entire surface 3 of the original 5 is scanned during the first scan. The data obtained by means of the first scan are transmitted to a computer 13 connected to the scanner 7. Subsequently, at least a second scan is carried out under changed conditions by means of the scanner 7. The condition that is changed in the illustrated embodiment is the exposure to light of the original 5 by means of the light sources 9, 11. During the first scan, the original is exposed to light from the light sources 9, 11 at a different angle of exposure than during the second scan, so that during the first scan substantially every point on the surface 3 of the original 5 is exposed to light of a different light intensity than during the second scan. The data obtained from the second scan are likewise transmitted to a computer 13 connected to the scanner 7. In the simplest variant, a first light source may be left on for the first scan whilst the second light source is left out, whilst the reverse is done for the second scan. In the computer 13, a digital three-dimensional image of the surface relief is provided on the basis of the differences in the measured light intensity of the various points on the surface measured during the first scan and the second scan.

It is also possible, for example, to use the same light intensity when exposing the surface 3 to light from the light sources 9, 11 during said at least two scans, whilst using a different surface scanning angle for the two scans. Changing the scanning angle can be done in a very simple manner by rotating the scanner at an acute angle, with the first scan being carried out at an angle of substantially 90 degrees with the surface and the second scan being carried out at an acute angle with the surface. The height of every point on the surface for the digital three-dimensional image of the surface is in that case determined on the basis of the scans carried out at different scanning angles, using a trigonometric measurement to be carried out by computer.

Furthermore, a digital colour image or colour data of the surface is/are provided by means of the computer 13 on the basis of the first scan and/or the second scan.

Subsequently, the data of the digital three-dimensional image of the relief on the surface 3 are converted in the computer 13 into machine instructions for a processing machine 15, such as a milling machine or relief-forming machines, such as a “3D print machine”, by means of which a mould 17 is formed.

Via the computer 13, the colour data of the scanned surface 3 are transmitted to a printer 19, by means of which a flat colour copy 21 is made.

The advantage of using the same scans for the colour image and the relief image is that said images will automatically fit exactly together.

In the next step, the flat colour copy 21 made on the basis of the colour data is positioned in the mould 17, by means of which mould 17 a three-dimensional, coloured reproduction 100 of the surface 3 can be made.

It is also possible not to carry out the colouring step, which is carried out by means of the printer 19 in the illustrated embodiment, until a three-dimensional reproduction of the surface 3 has been formed.

It is also possible to use other methods besides printing for colouring the three-dimensional reproduction. Instead of a printer, screen plates or offset plates may be used.

In FIG. 2, the various options for carrying out the above-described steps are shown in a clear flow diagram.

The scanner is preferably a line scanner.

The medium on which the flat colour copy is provided is preferably paper, cardboard or plastic. Said paper or cardboard is preferably embossed by means of the mould, so that said paper, whether coloured or not, forms a three-dimensional reproduction of the surface 3.

Instead of varying the scanning conditions by means of the light sources 9, 11, it is also possible to use different scanning angles of the scanner 7 for the first scan and the second scan.

1. A method for making a three-dimensional reproduction of a relief surface, which method comprises the following steps: scanning the surface at least twice by means of a scanner to be connected to a computer, the first scan being carried out under different conditions than the second scan, comparing the scans with each other by means of the computer in order to obtain a digital three-dimensional image of the surface relief, forming a mould by means of a processing machine on the basis of said digital three-dimensional image of the surface relief, making the three-dimensional reproduction of the surface by means of said mould.

2. A method according to claim 1, characterized by digitizing at least one scan by computer so as to obtain color data of the scanned surface.

3. A method according to claim 2, characterized by making a flat color copy on the basis of the color data, of which flat color copy a three-dimensional, colored reproduction of the surface can be made by means of the mould.

4. A method according to claim 1, characterized by digitizing at least one of the two scans by computer so as to obtain color data of the scanned surface for use in coloring the three-dimensional reproduction of the surface made by means of the mould.

5. A method according to claim 1, characterized by embossing paper, cardboard or plastic by means of the mould.

6. A method according to claim 1, characterized by thermoforming and/or vacuforming plastic by means of said mould.

7. A method according to claim 1, characterized in that the scanning conditions are varied for a first scan and a second scan, which is done either by varying an angle at which scanning takes place or by varying the exposure to light of the surface to be scanned, with the surface relief being digitized by computer by comparing the differences between the first scan and the second scan at every point on the scanned surface.

8. A method according to claim 6, characterized in that the exposure to light is varied for at least the first scan and the second scan, which is done either by varying the light intensity of at least two light sources for lighting the surface to be scans or by varying the lighting angle of at least one light source for lighting the surface to be scanned.

9. A method according to claim 6, characterized in that the surface to be scanned is continuously and uniformly exposed to light and a position of a scanner is moved after a first scan has been made so as to carry out the second scan, thus varying the angle at which scanning takes place.

10. A system for making a three-dimensional reproduction of a relief surface, which system comprises: a scanner to be connected to a computer for scanning the surface, as well as at least one light source, wherein a digital three-dimensional image of the surface relief can be obtained by means of at least two scans carried out under different conditions, a processing machine to be connected to the computer, by means of which a mould can be formed on the basis of a digital three-dimensional image of the surface relief, by means of which mould the three-dimensional reproduction of the surface can be made.

11. A system according to claim 9, characterized in that said system comprises at least two light sources, which are disposed some distance apart.

12. A system according to claim 9, characterized in that said scanner can be moved with respect to the surface to be scanned between two scans.

13. A system according to claim 9, characterized in that the scanning angle can be varied by rotating the scanner.

14. A system according to claim 9, characterized in that the system comprises a color printer connected to the computer or a device for making screen plates or offset plates, which is connected to the computer.
